(19) United States
(12) Patent Application Publication
(10) Pub. No.: US 2025/0044166 A1
(43) Pub. Date: Feb. 6, 2025

(54) THERMOMETER

(71) Applicant: Medical Indicators, Inc., Hamilton, NJ (US)

(72) Inventors: Ajey Shashikant Atre, Doylestown, PA (US); Bedwuine Senatus, Springfield, NJ (US); Ryan John Moy, Edison, NJ (US)

(73) Assignee: Medical Indicators, Inc., Hamilton, NJ (US)

(21) Appl. No.: 18/794,159

(22) Filed: Aug. 5, 2024

Related U.S. Application Data
(60) Provisional application No. 63/530,701, filed on Aug. 4, 2023.

(51) Int. Cl. G01K 11/165

(52) U.S. Cl. CPC G01K 11/165

(57) ABSTRACT

A thermometer includes a substrate, a cover layer, and a plurality of voids between the substrate and the cover layer. Each void contains at least one liquid crystal temperature sensing composition. The plurality of voids is arranged in at least one array (e.g., two rectangular arrays). The cover layer is located between the substrate and a biaxially-oriented polyester film. The thermometer may include at least two support layers on a side of the substrate opposite the cover layer and a biaxially-oriented polypropylene film/tape above a portion of the biaxially-oriented polyester film.

This application claims the priority benefit of U.S. Provisional Application No. 63/530,731, filed Aug. 4, 2023, and titled “THERMOMETER,” which is incorporated by reference in its entirety.

### BACKGROUND

The present exemplary embodiment relates to thermometers. It finds particular application in conjunction with reusable thermometers and will be described with particular reference thereto. However, it is to be appreciated that the present exemplary embodiment is also amenable to other like applications.

### BRIEF DESCRIPTION

The present disclosure relates to thermometers and, particularly, to thermometers which enable reusability (e.g., for 30 times or more).

Disclosed, in some embodiments, is a thermometer including: a substrate; an optically transparent cover layer; a plurality of voids between the substrate and the optically transparent cover layer, each void of the plurality of voids containing a liquid crystal temperature sensing composition; an ink layer; a biaxially-oriented polyester film, wherein the optically transparent cover layer is located between the substrate and the biaxially-oriented polypropylene film; a biaxially-oriented polypropylene film above a portion of the biaxially-oriented polyester film; at least one support layer on a side of the substrate opposite the optically transparent cover layer.

The ink layer may be located between the first support layer and the substrate. In some embodiments, the ink layer is printed on the substrate.

The thermometer may further include: an adhesive layer between the first support layer and the substrate.

In some embodiments, the adhesive layer between the first support layer and the substrate includes a urethane adhesive.

The thermometer may further include: a first heat seal adhesive layer between the substrate and the optically transparent cover layer.

In some embodiments, the thermometer further includes: a second heat seal adhesive layer between the biaxially-oriented polypropylene film and the substrate.

The optically transparent cover layer may include a polyester film.

In some embodiments, the polyester film is a polyethylene terephthalate film.

A polymer of the optically transparent cover layer may be unilaterally- or biaxially-oriented.

The at least one support layer may include a first support layer and a second support layer on a side of the first support layer opposite the substrate. In some embodiments, the first support layer and the second support layer include polypropylene films.

Optionally, the polypropylene films are oriented.

The substrate may include a polyester.

In some embodiments, the polyester is polyethylene terephthalate glycol.

The voids may be arranged in at least one rectangular array; the ink layer denotes a plurality of rows and a plurality of columns; and each void may be associated with a single row of the plurality of rows and a single column of the plurality of columns.

In some embodiments, the at least one rectangular array comprises two rectangular arrays.

The thermometer is generally reusable and may have a dwell time of less than 60 seconds, less than 55 seconds, less than 50 seconds, less than 45 seconds, less than 40 seconds, less than 35 seconds, or about 30 seconds.

The thermometer may further include a first pressure sensitive adhesive between the first support layer and the second support layer.

In some embodiments, the thermometer includes a second pressure sensitive adhesive associated with at least one surface of the biaxially-oriented polypropylene layer.

Disclosed, in further embodiments, is a reusable thermometer having a dwell time of about 60 seconds. The thermometer includes: a substrate comprising PETG; an optically transparent cover layer; a first support layer on a side of the substrate opposite the optically transparent cover layer; a second support layer on a side of the first support layer opposite the substrate; a plurality of voids between the substrate and the optically transparent cover layer, each void of the plurality of voids containing a liquid crystal temperature sensing composition; an ink layer; a biaxially-oriented PET film, wherein the optically transparent cover layer is located between the substrate and the biaxially-oriented polypropylene film; a biaxially-oriented polypropylene film above the substrate and extending partially between the substrate and the biaxially-oriented polyester film.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a known thermometer for measuring temperatures in ° F.

FIG. 2 illustrates a known thermometer for measuring temperatures in ° C.

FIG. 3 illustrates a thermometer in accordance with some embodiments of the present disclosure for measuring temperatures in ° F.

FIG. 4 illustrates a thermometer in accordance with some embodiments of the present disclosure for measuring temperatures in ° C.

### DETAILED DESCRIPTION

The present disclosure may be understood more readily by reference to the following detailed description of desired embodiments included therein, the drawings. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

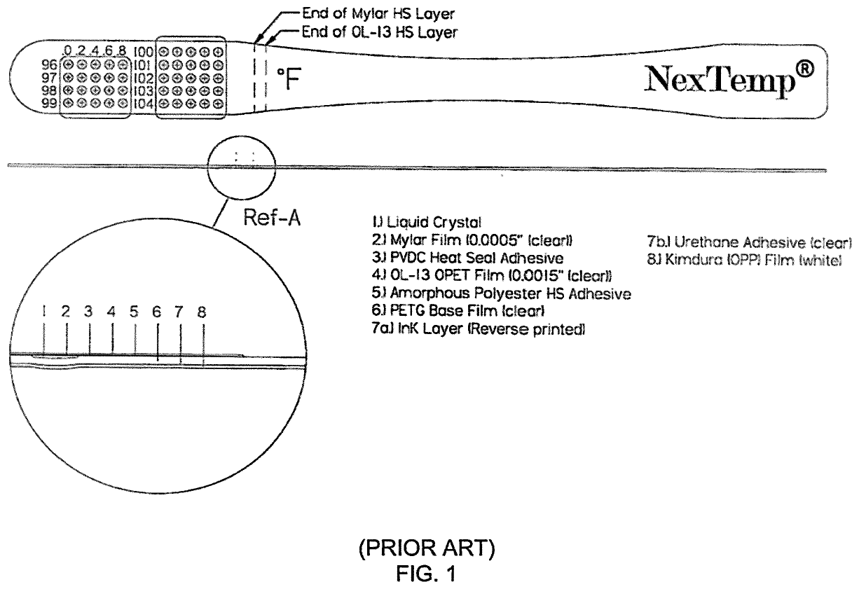

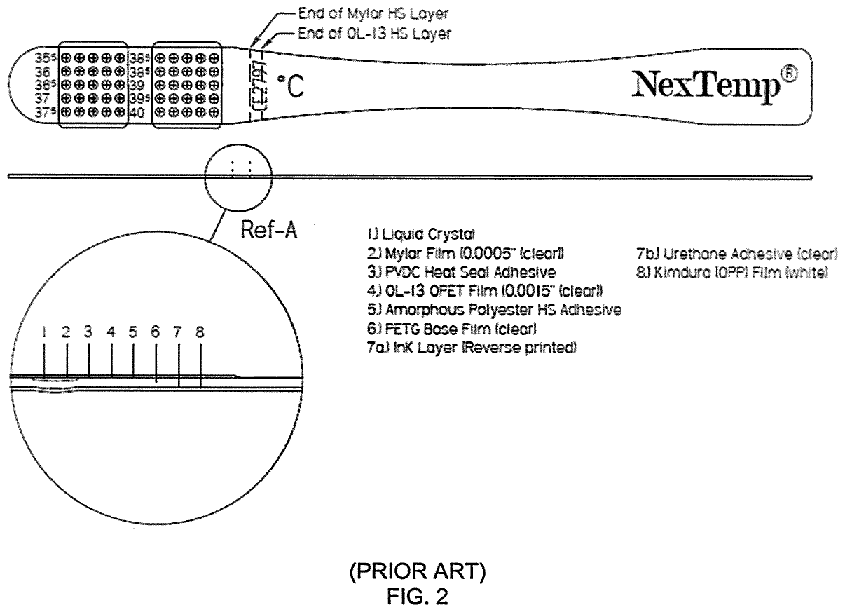

FIGS. 1 and 2 illustrates known thermometers which include liquid crystal temperature sensing elements 1, a transparent MYLAR® film 2, a heat seal adhesive 3 (e.g., a PVDC heat seal adhesive), a transparent OL-13 OPET film 4, an amorphous polyester heat seal adhesive 5, a transparent PETG film 6, an ink layer 7a, a transparent urethane adhesive 7b, and a white Kimdura (OPP) film 8. The thermometer of FIG. 1 is a single-use thermometer and has a required dwell time of 60 seconds. The thermometers of FIGS. 1 and 2 are for measuring temperature in ° F. and ° C., respectively.

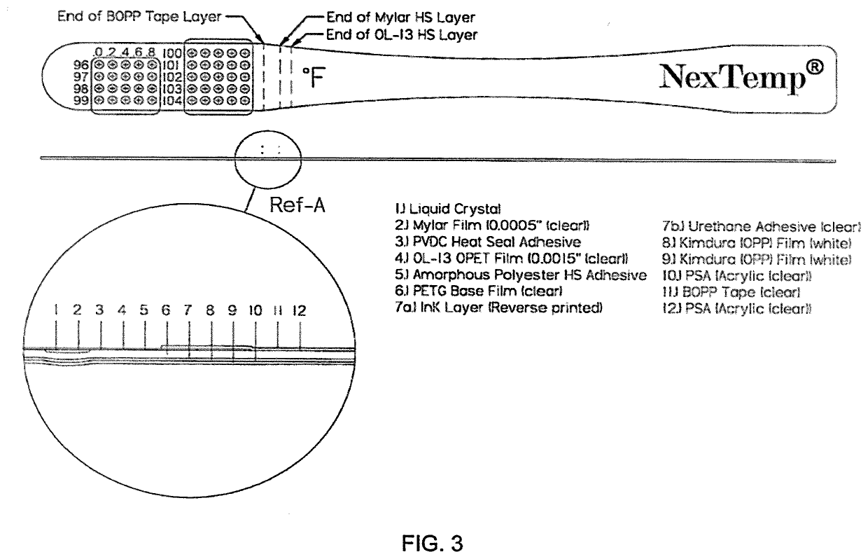

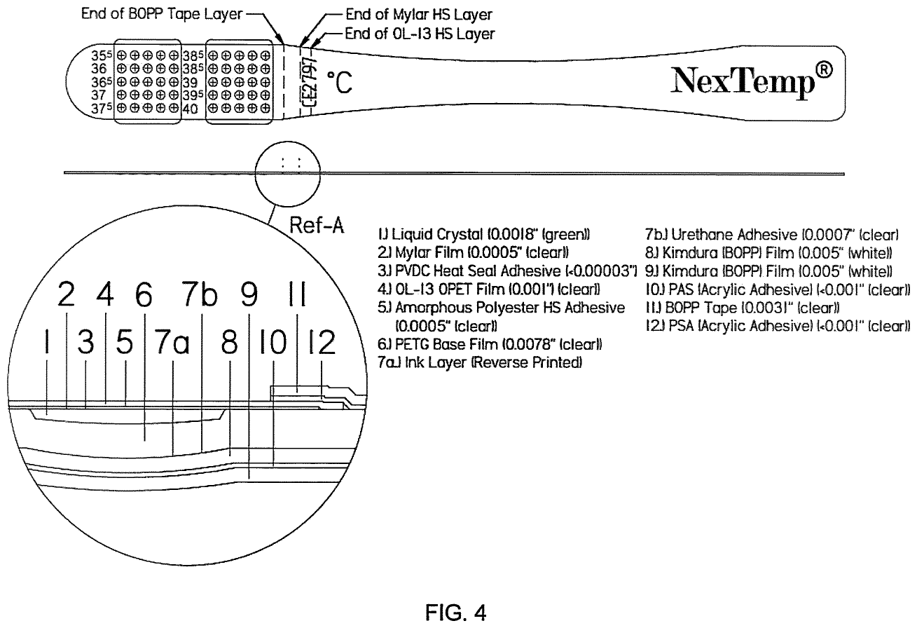

FIGS. 3 and 4 illustrate a thermometer in accordance with some embodiments of the present disclosure for measuring temperature in ° F. and ° C., respectively. The thermometer includes a handle region and a sensing head region. The thermometer includes a substrate 6 and an optically transparent cover layer 2. The substrate 6 includes a plurality of wells/voids which are at least partially filled with liquid crystal temperature sensing compositions 1. The optically transparent cover layer 2 may be secured to the substrate 6 via a first adhesive layer 3 (e.g., a heat seal adhesive layer such as a PVDC adhesive layer). An ink layer 7a is provided between the substrate 6 and a support layer first support layer 8. A second support layer 9 may be secured to the first support layer 8 via a second adhesive layer 10 (e.g., a pressure sensitive adhesive such as an acrylic adhesive). In other embodiments, a single, thicker support layer is utilized instead of two or more distinct layers. In such embodiments, the second adhesive layer 10 can be omitted. The ink layer 7a may be printed on the substrate 6 or the support layer 8. Alternatively, the ink layer 7a may be provided on the other surface of the substrate 6. The substrate 6 and support layer 8 may be secured together via a third adhesive layer 7b (e.g., a urethane adhesive layer). The thermometer further includes a biaxially-oriented polypropylene film or tape 11. The biaxially-oriented polypropylene film 11 may be secured to the substrate 6 via a fourth adhesive layer 12 (e.g., a pressure sensitive adhesive layer such as an acrylic adhesive layer). The thermometer further includes a biaxially-oriented polyester (e.g., PET) film 4 on the substrate 6 and extending partially between the substrate 6 and the biaxially-oriented polypropylene film 11. A fifth adhesive layer 5 (e.g., a heat seal layer such as an amorphous polyester adhesive layer) may be provided between the biaxially-oriented polyester layer 4 and the biaxially-oriented polypropylene film 11.

### Biaxially-Oriented Polypropylene Film/Tape 11

The biaxially-oriented polypropylene film/tape 11 may have a thickness in a range of about 0.001 to about 0.01 inches, including from about 0.002 to about 0.004 inches, and about 0.0031 inches.

The inclusion of the biaxially-oriented polypropylene film or tape 11 enables the dwell time to be reduced and durability/rigidity to be increased.

### First Support Layer 8

To support the substrate 6 and protect the ink layer 7a from abrasion during the manufacturing process and subsequently during use, a support layer 8 can be included. The support layer 8 may be a transparent or colored plastic film that can be adhesively bound to the substrate 6.

Non-limiting embodiments of suitable first support layer 8 materials include white polypropylene (e.g., unilaterally- or biaxially-oriented polypropylene), polyethylene, or polyester.

The first support layer 8 may have a thickness in a range of about 0.001 to about 0.009 inches, including from about 0.004 to about 0.006 inches, and about 0.005 inches.

### Second Support Layer 9

The second support layer 9 increases the durability and rigidity of the thermometer, thereby enabling reusability.

Non-limiting embodiments of suitable second support layer 9 materials include white polypropylene, polyethylene, or polyester.

The composition of the second support layer 9 may be the same as or different from the composition of the first support layer 8.

The second support layer 9 may have a thickness in a range of about 0.001 to about 0.009 inches, including from about 0.004 to about 0.006 inches, and about 0.005 inches.

For embodiments utilizing a single, thicker support layer instead of multiple support layers, the thickness may be in a range of about 0.002 to about 0.018 inches, including from about 0.008 to about 0.012 inches, and about 0.010 inches.

### Substrate 6

The substrate 6 may be transparent, particularly when the ink layer is provided on the back side, and the material thereof is generally embossable to enable the voids for the liquid crystalline compositions to be created. The substrate material must be inert with respect to the liquid crystals and contain no residual low molecular substances from its processing that could migrate into and contaminate the liquid crystals. Moreover, the substrate 6 is generally heat sealable to other thin transparent inert plastic films.

The substrate 6 may include a polyester. The polyester may be a copolymer such as polyethylene terephthalate glycol. The polyethylene terephthalate glycol may have a glass transition temperature in a range of about 80° C. to about 85° C., including about 81° C.

The substrate 6 may have a thickness in a range of about 0.006 to about 0.01 inches, from about 0.007 to about 0.009 inches, and about 0.078 inches.

### Cover Layer 2

The optically transparent cover layer 2 must also be inert with respect to the liquid crystals, transparent, heat sealable to the substrate, and contain no low molecular weight components which can migrate into the liquid crystal composition through the heat-sealing process or subsequently during storage.

Non-limiting examples include polyvinylidene chloride and polyester (e.g., polyethylene terephthalate and/or polyethylene terephthalate glycol). Laminates containing one or more of these materials are also contemplated.

The optically transparent cover layer 2 may have a thickness in a range of about 0.0001 inches to about 0.0009 inches, including about 0.0004 to about 0.0006 inches, and about 0.0005 inches.

### Liquid Crystal-Filled Voids 1

Non-limiting aspects of liquid crystal temperature sensing compositions and their utilization are disclosed in U.S. Pat. No. 5,676,465, issued Oct. 14, 1997, and titled “LIQUID CRYSTAL CLINICAL THERMOMETER” which is incorporated by reference herein in its entirety. The thickness may be about 0.0018 inches.

The liquid crystal composition temperature sensing elements 1 may be arranged in at least one rectangular array and each element 1 may be associated with a temperature increment of 0.1° C. or 0.2° F. or less.

The encompassed temperature range may be 96.0 to 104.8° F. (FIG. 3) or 35° C. to 41° C. (FIG. 4).

In some embodiments, each element 1 includes a void volume being defined by a substrate and a cover layer, the void volume containing therein a composition including at least one cholesteric liquid crystal chemical temperature sensing composition which occupies about 50 to about 90% of the volume of the void volume, the composition being configured in a toroidal shaped ring along a circumferential region defined by the intersection of the substrate and cover layer and the cover layer optionally having a convex configuration. The liquid crystal chemical temperature sensing composition may be in contact with the convex cover layer and have a convex shape. the portion of the void volume not containing the liquid crystal composition may contain air.

In some embodiments, the cholesteric liquid crystal composition contains about 57.9 wt % of cholesteryl oleyl carbonate; 30.7 wt % of cholesteryl chloride, and 11.4 wt % of cholesteryl-n-butoxyphenyl carbonate. The liquid crystal composition may contain a dopant that impacts its visual properties.

The liquid crystal composition may fill about 65 to about 85% of the void volume or about 70 to about 80% of the void volume.

### Ink Layer 7a

The ink layer 7a may be printed on the frontside or the backside of the substrate

6. The ink layer 7a may provide labels and layout for the temperature-sensing element matrices 1. For example, the ink layer may define a plurality of columns and a plurality of rows that enable each individual temperature-sensing element 1 to be associated with a 0.1° C. or 0.2° F. increment.

The ink may be a black ink.

### Biaxially-Oriented Polyester Film 4

The biaxially-oriented polyester (e.g., PET) film 4 may be an OL-13 OPET film.

The biaxially-oriented polyester film/tape 4 may have a thickness in a range of about 0.0005 to about 0.002 inches, including from about 0.0009 to about 0.0011 inches, and about 0.001 inches.

The biaxially-oriented polyester tape/film may be replaced with a unilaterally- or biaxially-oriented polypropylene layer.

### Adhesives

Where multiple adhesive layers are utilized, they may be of the same or different types.

When multiple adhesive layers of the same type are utilized, they may be the same or different. For example, when two or more pressure sensitive adhesive layers are used, they may be the same or different and when two or more heat seal adhesive layers are used they may be the same or different.

### First Adhesive Layer 3

The first adhesive layer 3 may be a heat seal adhesive.

In some embodiments, the first adhesive layer 3 includes a PVDC adhesive. The heat seal adhesive may function as a vapor barrier in addition to the heat seal adhesive functionality.

### Second Adhesive Layer 10

The first adhesive layer 10 may be a pressure sensitive adhesive.

In some embodiments, the first adhesive layer 10 comprises an acrylic adhesive.

### Third Adhesive Layer 7b

The third adhesive layer 7b may contain a pressure sensitive adhesive to secure the substrate 6 to the support layer 8.

In some embodiments, the third adhesive includes a urethane adhesive.

### Fourth Adhesive Layer 12

The fourth adhesive layer 12 may be a pressure sensitive adhesive.

In some embodiments, the fourth adhesive layer 12 includes an acrylic adhesive.

### Fifth Adhesive Layer 5

The fifth adhesive layer 5 may be a heat seal adhesive.

In some embodiments, the first adhesive layer 5 comprises an amorphous polyester adhesive or a urethane adhesive.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A reusable thermometer comprising:
a substrate comprising PETG;
an optically transparent cover layer;
a first support layer on a side of the substrate opposite the optically transparent cover layer; and
a second support layer on a side of the first support layer opposite the substrate;
a plurality of voids between the substrate and the optically transparent cover layer, each void of the plurality of voids containing a liquid crystal temperature sensing composition;
an ink layer;
a biaxially-oriented PET film, wherein the optically transparent cover layer is located between the substrate and the biaxially-oriented polypropylene film;
a biaxially-oriented polypropylene film above a portion of the biaxially-oriented polyester film.

2. A thermometer comprising:
a substrate;
an optically transparent cover layer;
a plurality of voids between the substrate and the optically transparent cover layer, each void of the plurality of voids containing a liquid crystal temperature sensing composition;
an ink layer;
a biaxially-oriented polyester film, wherein the optically transparent cover layer is located between the substrate and the biaxially-oriented polypropylene film;
a biaxially-oriented polypropylene film above a portion of the biaxially-oriented polyester film;
at least one support layer on a side of the substrate opposite the optically transparent cover layer.

3. The thermometer of claim 2, wherein the ink layer is located between the support layer and the substrate.

4. The thermometer of claim 3, wherein the ink layer is printed on the substrate.

5. The thermometer of claim 2, further comprising an adhesive layer between the support layer and the substrate.

6. The thermometer of claim 5, wherein the adhesive layer comprises a transparent urethane adhesive.

7. The thermometer of claim 2, further comprising:
a first heat seal adhesive layer between the substrate and the optically transparent cover layer.

8. The thermometer of claim 2, further comprising:
a second heat seal adhesive layer between the biaxially-oriented polypropylene film and the substrate.

9. The thermometer of claim 2, wherein the optically transparent cover layer comprises a polyester film.

10. The thermometer of claim 8, wherein the polyester film is a polyethylene terephthalate film.

11. The thermometer of claim 9, wherein the polyester film is biaxially-oriented.

12. The thermometer of claim 2, wherein the at least one support layer comprises a first support layer; and a second support layer on a side of the first support layer opposite the substrate.

13. The thermometer of claim 12, wherein the first support layer and the second support layer are polypropylene films.

14. The thermometer of claim 13, wherein the polypropylene films are oriented polypropylene films.

15. The thermometer of claim 2, wherein the substrate comprises a polyester.

16. The thermometer of claim 15, wherein the polyester is polyethylene terephthalate glycol.

17. The thermometer of claim 2, wherein the voids are arranged in at least one rectangular array; wherein the ink layer denotes a plurality of rows and a plurality of columns; and wherein each void is associated with a single row of the plurality of rows and a single column of the plurality of columns.

18. The thermometer of claim 2, wherein the thermometer is reusable and has a dwell time of less than 60 seconds.

19. The thermometer of claim 12, further comprising:
a pressure sensitive adhesive between the first support layer and the second support layer.

20. The thermometer of claim 2, further comprising:
a pressure sensitive adhesive associated with at least one surface of the biaxially-oriented polypropylene layer.
